(19) United States
(12) Patent Application Publication
(10) Pub. No.: US 2025/0266038 A1
(43) Pub. Date: Aug. 21, 2025

(54) SYSTEM AND METHOD FOR MANAGING EXECUTION PLAN FOR ARTIFICIAL INTELLIGENCE BASED ASSISTANCE DEVICE

(71) Applicant: SAMSUNG ELECTRONICS CO., LTD., Suwon-si (KR)

(72) Inventors: Manjunath Belgod LOKANATH, Bengaluru (IN); Shivani Arora, Kotkapura (IN); Vishwanath Pethri Kamath, Brahmavara (IN); Ratnesh Kumar Yadav, Bengaluru (IN); Vaibhav Ittan, Jaipur (IN)

(73) Assignee: SAMSUNG ELECTRONICS CO., LTD., Suwon-si (KR)

(21) Appl. No.: 19/056,388

(22) Filed: Feb. 18, 2025

Related U.S. Application Data
(63) Continuation of application No. PCT/KR2025/001930, filed on Feb. 10, 2025.

(30) Foreign Application Priority Data
Feb. 21, 2024 (IN) 202441012349
Dec. 31, 2024 (IN) 202441012349

(51) Int. Cl. G10L 15/22; G10L 15/26

(52) U.S. Cl. CPC G10L 15/22; G10L 15/26; G10L 2015/223

(57) ABSTRACT

A method for managing an execution plan for an artificial intelligence (AI)-based assistance device includes receiving a first input indicating a voice command from a user; determining a first context associated with the AI-based assistance device and a user intent, based on the first input; generating first and second execution plans based on the first context; generating a first timeline connecting the first and second execution plans; detecting a change from the first context based on the first timeline and a second context of the AI-based assistance device or the user; generating an updated execution plan based on the change; and generating a second timeline by modifying the first timeline based on the updated execution plan.

### CROSS-REFERENCE TO RELATED APPLICATION

This application is a by-pass continuation application of International Application No. PCT/KR2025/001930, filed on Feb. 10, 2025, which is based on and claims priority to Indian Provisional Patent Application No. 202441012349, filed in the Indian Patent Office on Feb. 21, 2024, and Indian Complete patent application Ser. No. 202441012349, filed in the Indian Patent Office on Dec. 31, 2024, the disclosures of which are incorporated by reference herein in their entireties.

### BACKGROUND

### 1. Field

The present disclosure relates to a field of artificial intelligence (AI) based assistance devices, and more particularly, relates to a method and a system for managing an execution plan for an artificial intelligence (AI) based assistance device.

### 2. Description of Related Art

In recent years, artificial intelligence (AI) based assistance devices (referred to here as devices) have revolutionized the way users interact with technology. The devices are gadgets equipped with programming/software that allow users to perform tasks through voice commands. These devices execute a plurality of functions, for example, setting reminders, and alarms, playing music, controlling smart home appliances, or providing weather updates. These devices ensure hand-free control, enhancing the user experience.

Currently, for operating these devices, the users typically issue commands and receive responses for each task. However, the operation performed by these devices has certain limitations. For example, when a user issues a command to a device for performing an operation, then the user receives a response for that operation only, e.g., single input and single output to execution completion. The user receives the response without any further proactive engagement or assistance from the device. An execution plan created for each of the commands provided by the user is static and does not have a dependency on other commands. The execution plan is created corresponding to the command and is not adaptive. This means that after executing the command, the user must independently think about and interact with the device for subsequent tasks. For example, as shown in FIG. 1, the user issues the command 102 to set an alarm for 5 AM for travelling to X place. In that case, the device only sets the alarm 104 for 5 AM and does not provide any further proactive engagement, suggestion, or assistance to the user.

This results in a lack of continuity and assistance beyond individual commands, requiring users to repeatedly engage with the device for each subsequent task, therefore increasing the discomfort of the user.

The prior known solutions in this field focus on predicting future user activities based on past occurrences, often centered around user physical context or activities like sleep patterns or exercise routines. These approaches do not involve analyzing a comprehensive range of potential tasks that the user may not have performed historically or even considered yet.

In view of the above-mentioned problems, it is advantageous to provide an improved system and method that overcome one or more above-mentioned problems/challenges associated with the device.

### SUMMARY

According to an aspect of the disclosure, a method for managing an execution plan for an artificial intelligence (AI)-based assistance device includes receiving a first input indicating a voice command from a user; determining a first context associated with the AI-based assistance device and a user intent, based on the first input; generating first and second execution plans based on the first context; generating a first timeline connecting the first and second execution plans; detecting a change from the first context based on the first timeline and a second context of the AI-based assistance device or the user; generating an updated execution plan based on the change; and generating a second timeline by modifying the first timeline based on the updated execution plan.

According to an aspect of the disclosure, a method for managing an execution plan for an artificial intelligence (AI)-based assistance device includes receiving a first input, via a microphone, indicating a voice command from a user; determining a first context associated with the AI-based assistance device and a user intent, based on the first input; generating a first execution plan, based on the first context, wherein the first execution plan indicates one or more first tasks to be executed in response to the first context, and one or more second execution plans, based on the first context, wherein the one or more second execution plans indicate one or more second tasks to be executed in response to the first context; generating a first timeline connecting the first execution plan and the one or more second execution plans; detecting a change from the first context based on the first timeline and at least one of a second context of the AI-based assistance device or a second context of the user; generating an updated execution plan based on the change; and generating a second timeline by modifying the first timeline based on the updated execution plan.

According to an aspect of the disclosure, a system for managing an execution plan for an artificial intelligence (AI)-based assistance device, the system includes memory storing instructions; at least one processor in communication with the memory, wherein the instructions, when executed by the at least one processor, cause the system to receive a first input, via a microphone, indicating a voice command from a user; determine a first context associated with the AI-based assistance device and a user intent, based on the first input; generate a first execution plan, based on the first context, wherein the first execution plan indicates one or more first tasks to be executed in response to the first context, and one or more second execution plans, based on the first context, wherein the one or more second execution plans indicate one or more second tasks to be executed as response to the first context; generate a first timeline connecting the first execution plan and the one or more second execution plans; detect a change from the first context based on the first timeline and at least one of a second context of the AI-based assistance device or a second context of the user; generate an updated execution plan based on the change; and generate a second timeline by modifying the first timeline based on the updated execution plan.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrate operations performed by an artificial intelligence (AI) based assistance device;

FIG. 2 illustrates an environment for managing an execution plan for an artificial intelligence (AI) based assistance device, in accordance with an embodiment of the present disclosure;

FIG. 3 illustrates a block diagram of a system for managing the execution plan of AI based assistance device, in accordance with an embodiment of the present disclosure;

FIG. 4 illustrates an architecture of the system for managing the execution plan for the AI based assistance device, in accordance with an embodiment of the present disclosure;

FIGS. 5A and 5B illustrate determination of a first context, a first execution plan, and one or more second execution plans by the system, in accordance with an embodiment of the present disclosure;

FIGS. 5C and 5D illustrate the first execution plan and one or more second execution plans, in accordance with an embodiment of the present disclosure;

FIG. 6 illustrates the generation of a first timeline and a second timeline by the system, in accordance with an embodiment of the present disclosure;

FIG. 7 illustrates the operation of a dynamic execution plan generator, in accordance with an embodiment of the present disclosure;

FIG. 8 illustrates a flowchart depicting a method for managing the execution plan for the device, in accordance with an embodiment of the present disclosure;

FIG. 9 illustrates an example timeline representation of a use case scenario implementation of the system and the method to generate the first execution plan based on the first input from the user, in accordance with an embodiment of the present disclosure; and

FIGS. 10A and 10B illustrate another example timeline representation of a use-case scenario, in accordance with an embodiment of the present disclosure.

### DETAILED DESCRIPTION

For the purpose of promoting an understanding of the principles of the present disclosure, reference will now be made to the various embodiments and language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” The use of the terms “one or more” or “at least one” feature or element does not preclude there being none of that feature or element, unless otherwise specified by limiting language including, but not limited to, “there may be one or more . . . ” or “one or more elements is required.”

The expressions “at least one of A, B and C” and “at least one of A, B, or C”, both indicate “A”, only “B”, only “C”, both “A and B”, both “A and C”, both “B and C”, and all of “A, B, and C”.

Reference is made herein to some “embodiments.” It should be understood that an embodiment is an example of an implementation of any features and/or elements of the present disclosure. Some embodiments have been described for the purpose of explaining one or more of the potential ways in which the features and/or elements of the disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may be realized as existing together in the context of a single embodiment.

All details set forth herein are used in the context of some embodiments and therefore should not be taken as limiting the disclosure.

The terms “comprises,” “comprising,” or any other variations thereof, are intended to cover a non-exclusive inclusion, such that a process or method that comprises a list of steps does not include only those steps but may include other steps not expressly listed or inherent to such process or method. One or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in detail with reference to the accompanying drawings.

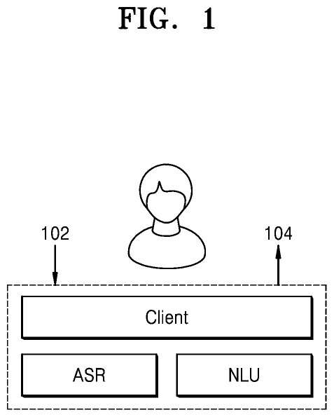

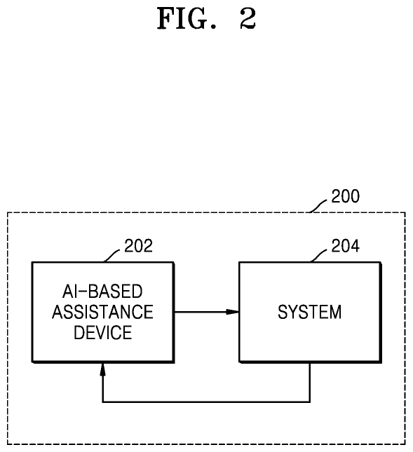

For the sake of clarity, the first digit of a reference numeral of each component of the present disclosure is indicative of the FIG. number, in which the corresponding component is shown. For example, reference numerals starting with digit “1” are shown at least in FIG. 1. Similarly, reference numerals starting with digit “2” are shown at least in FIG. 2.

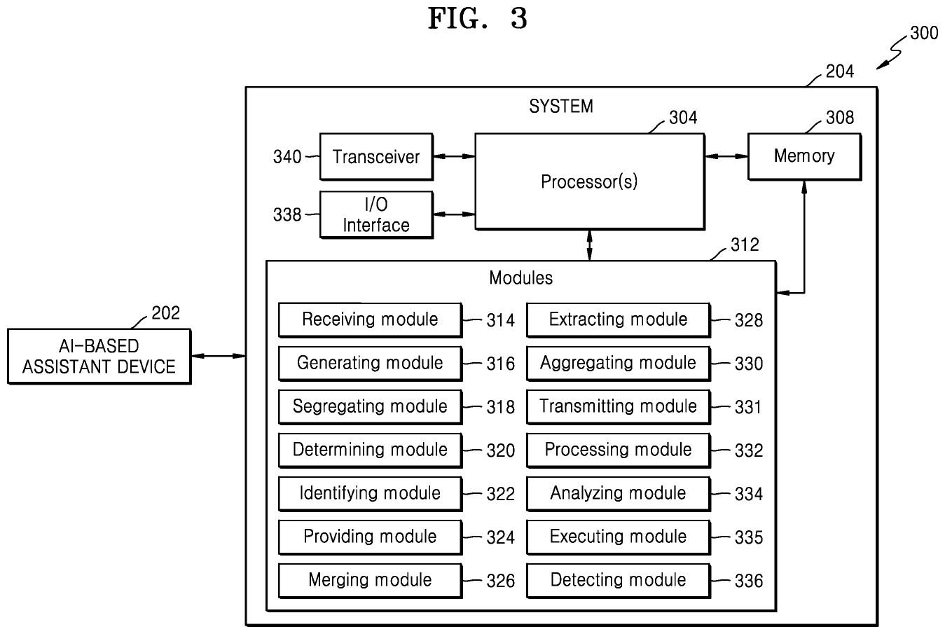

FIG. 2 illustrates an environment 200 for managing an execution plan for an artificial intelligence (AI) based assistance device 202, in accordance with an embodiment of the present disclosure. FIG. 3 illustrates a block diagram 300 of a system 204 for managing the execution plan of AI based assistance device 202, in accordance with an embodiment of the present disclosure.

In an embodiment, the artificial intelligence (AI) based assistance device (referred to herein as a device) 202 may be any device which may operate based on a command/instruction received from a user, without departing from the scope of the present disclosure. When the device 202 receives the command/instruction from the user to perform some tasks, in that case, the device 202 only generates an output based on the command/instruction provided by the user and lacks continuity and assistance beyond individual commands. The system 204 may be in communication with the device 202. The system 204 may be configured to operate based on a plurality of inputs, in such a manner that the system 204 manages the execution plan for the device 202. Based on the management, the device 202 may provide customized proactiveness, assistance, and suggestions based on a task, to the user. Thus, ensuring the comfort of the user. In another embodiment, the system 204 may be deployed within the device 202, without departing from the scope of the present disclosure.

In an embodiment, the system 204 may include, but is not limited to, at least one processor 304 (referred to here as a processor 304), a memory 308, and a plurality of modules 312, among other examples which are explained in detail in subsequent paragraphs.

The system 204 may include an Input/Output (I/O) interface 338 and a transceiver 340. In some embodiments where the system 204 is implemented as a standalone entity at a server/cloud architecture, the system 204 may be in communication with multiple devices to receive data from each of the multiple devices, and the details provided below with respect to the system 204 and the device 202 are applicable for the system 204 and the multiple devices as well.

In an example embodiment, the processor 304 may be operatively coupled to each of the I/O interface 338, the plurality of modules 312, the transceiver 340, and the memory 308. In one embodiment, the processor 304 may include a graphical processing unit (GPU) and/or an artificial intelligence engine (AIE). In one embodiment, the processor 304 may include at least one data processor for executing processes in a virtual storage area network. The processor 304 may include specialized processing units such as integrated system (bus) controllers, memory management control units, floating point units, graphics processing units, or digital signal processing units, for example. In one embodiment, the processor 304 may include a central processing unit (CPU), a graphics processing unit (GPU), or both. The processor 304 may be one or more general processors, digital signal processors, application-specific integrated circuits, field-programmable gate arrays, servers, networks, digital circuits, analog circuits, combinations thereof, or other now-known or later developed devices for analyzing and processing data. The processor 304 may execute a software program, such as code generated manually (e.g., programmed) to perform the desired operation.

The processor 304 may be disposed in communication with one or more input/output (I/O) devices via the I/O interface 338. In some embodiments, the processor 304 may communicate with the device 202 using the I/O interface 338. In some embodiments, the I/O interface 338 may be implemented within the device 202. The I/O interface 338 may employ communication code-division multiple access (CDMA), high-speed packet access (HSPA+), global system for mobile communications (GSM), long-term evolution (LTE), WiMax, or the like. In an embodiment, the I/O interface 338 may enable input and output to and from the system 204 using devices such as, but not limited to, display, keyboard, mouse, touch screen, microphone, speaker, and so forth.

Using the I/O interface 338, the system 204 may communicate with one or more I/O devices, the device 202, to which the system 204 manages the execution plan for the device 202. For example, the input device may be an antenna, microphone, touch screen, touchpad, storage device, transceiver, or video device/source. The output devices may be a video display (e.g., cathode ray tube (CRT), liquid crystal display (LCD), light-emitting diode (LED), plasma, Plasma Display Panel (PDP), Organic light-emitting diode display (OLED) or the like), or an audio speaker, for example.

The processor 304 may be disposed in communication with a communication network via a network interface. In an embodiment, the network interface may be the I/O interface 338. The network interface may connect to the communication network to enable the connection of the system 204 with the device 202. The network interface may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network may include, without limitation, a direct interconnection, local area network (LAN), wide area network (WAN), wireless network (e.g., using Wireless Application Protocol), or the Internet, for example. Using the network interface and the communication network, the system 204 may communicate with other devices. The network interface may employ connection protocols including, but not limited to, direct connect, Ethernet (e.g., twisted pair 10/100/1000 Base T), transmission control protocol/internet protocol (TCP/IP), token ring, or IEEE 802.11a/b/g/n/x, for example.

The transceiver 340 may be configured to receive and/or transmit signals to and from the device 202. In one embodiment, the database may be configured to store the information, and the processor 304 may perform one or more functions for managing the execution plan for the device 202.

In some embodiments, the memory 308 may be communicatively coupled to the processor 304. The memory 308 may be configured to store data, and instructions executable by the processor 304 to perform the one or more methods disclosed herein throughout the present disclosure. In one embodiment, the memory 308 may be provided within the device 202. In another embodiment, the memory 308 may be provided within the system 204 being remote from the device 202. In yet another embodiment, the memory 308 may communicate with the processor 304 via a bus within the system 204. In yet another embodiment, the memory 308 may be located remote from the processor 304 and may be in communication with the processor 304 via a network. The memory 308 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In one example, the memory 308 may include a cache or random-access memory for the processor 304. In alternative examples, the memory 308 is separate from the processor 304, such as a cache memory of a processor, the system memory, or other memory. The memory 308 may be an external storage device or database for storing data. The memory 308 may be operable to store instructions executable by the processor 304. The functions, acts, or tasks illustrated in the figures or described may be performed by the programmed processor 304 for executing the instructions stored in the memory 308. The functions, acts, or tasks are independent of the particular type of instruction set, storage media, processor, or processing strategy and may be performed by software, hardware, integrated circuits, firmware, micro-code and the like, operating alone or in combination. Likewise, processing strategies may include multiprocessing, multitasking, parallel processing, and the like.

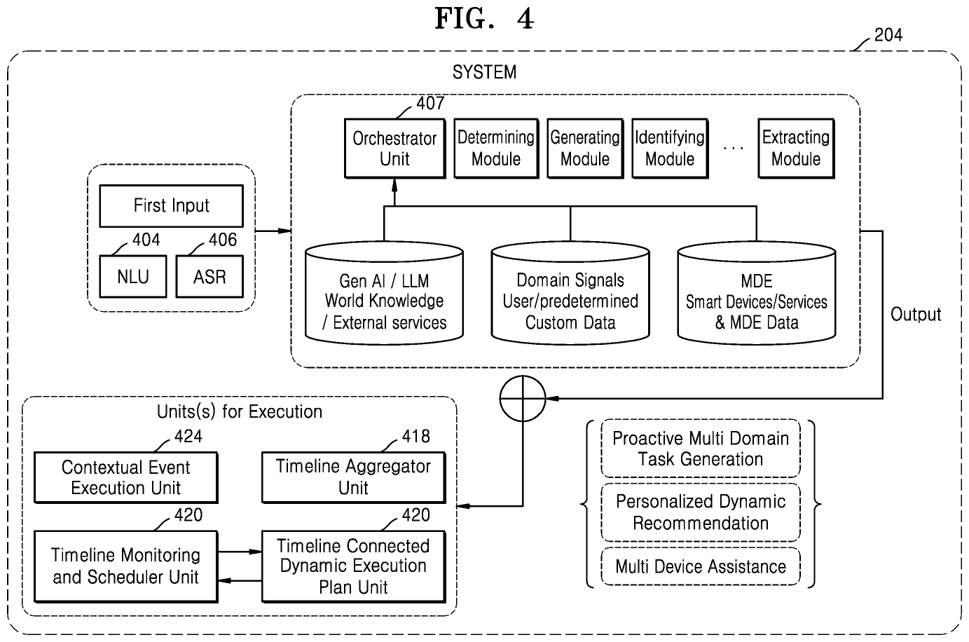

In some embodiments, the plurality of modules 312 may be included within the memory 308. The memory 308 may further include a database to store data. The plurality of modules 312 may include a set of instructions that may be executed to cause the system 204, the processor 304 of the system 204, to perform any one or more of the methods/processes disclosed herein. The plurality of modules 312 may be configured to perform the steps of the present disclosure using the data stored in the database. For instance, the plurality of modules 312 may be configured to perform the techniques disclosed in FIGS. 4 to 7.

In an embodiment, each of the plurality of modules 312 may be a hardware unit which may be outside the memory 308. The memory 308 may include an operating system for performing one or more tasks of the system 204, as performed by a generic operating system.

In one example, the plurality of modules 312 may include a receiving module 314, a generating module 316, a segregating module 318, a determining module 320, an identifying module 322, a providing module 324, a merging module 326, an extracting module 328, an aggregating module 330, a transmitting module 331, a processing module 332, an analyzing module 334, an executing module 335, and a detecting module 336. Each of the modules 314-336 may be in communication with each other. Each of the modules 314-336 may be in communication with the processor 304.

The present disclosure contemplates a computer-readable medium that includes instructions or receives and executes instructions responsive to a propagated signal. The instructions may be transmitted or received over the network via a communication port or interface or using a bus. The communication port or interface may be a part of the processor 304 or may be a separate component. The communication port may be created in software or may be a physical connection in hardware.

The communication port may be configured to connect with a network, external media, the display, or any other components in the system, or combinations thereof. The connection with the network may be a physical connection, such as a wired Ethernet connection, or may be established wirelessly. Likewise, the additional connections with other components of the system 204 may be physical or may be established wirelessly. The network may be directly connected to a bus. For the sake of brevity, the architecture and standard operations of the memory 308, the processor 304, the transceiver 340, and the I/O interface 338 are not discussed in detail.

In an embodiment, the working of the system 204 to manage the execution plan for the device 202 is explained in detail. The processor 304, in conjunction with the receiving module 314, the generating module 316, the segregating module 318, the determining module 320, the identifying module 322, the providing module 324, the merging module 326, the extracting module 328, the aggregating module 330, the transmitting module 331, the processing module 332, the analyzing module 334, the executing module 335, and the detecting module 336 may be configured to perform operations explained in paragraphs in conjunction with FIG. 4 to FIG. 7 in subsequent paragraphs.

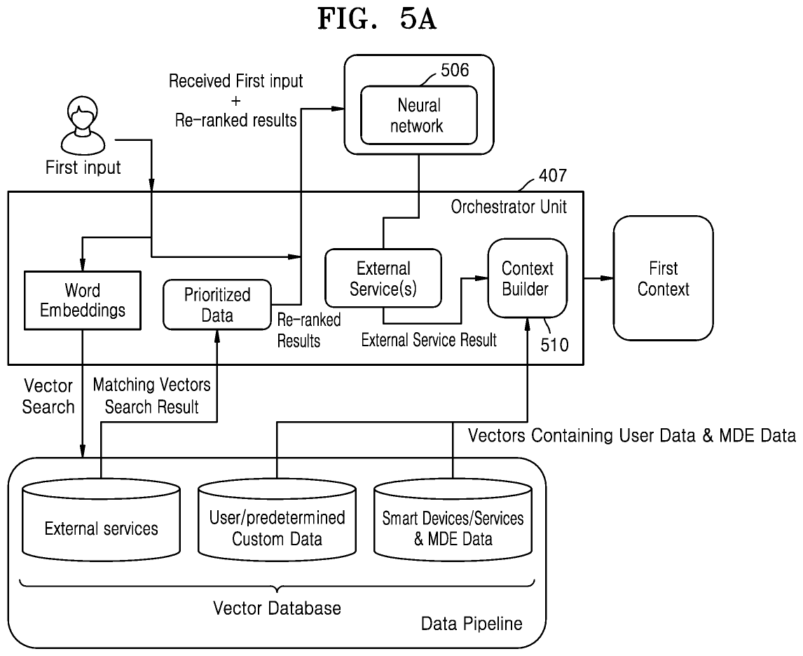

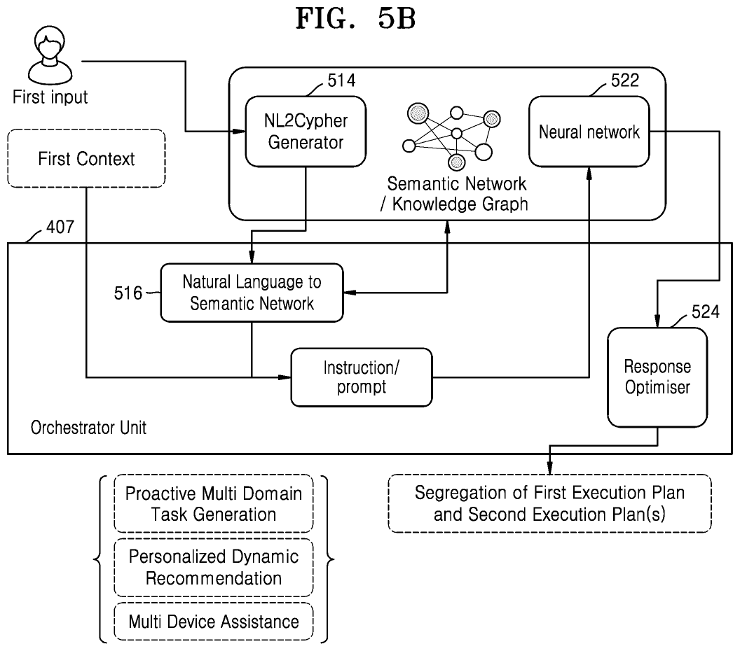

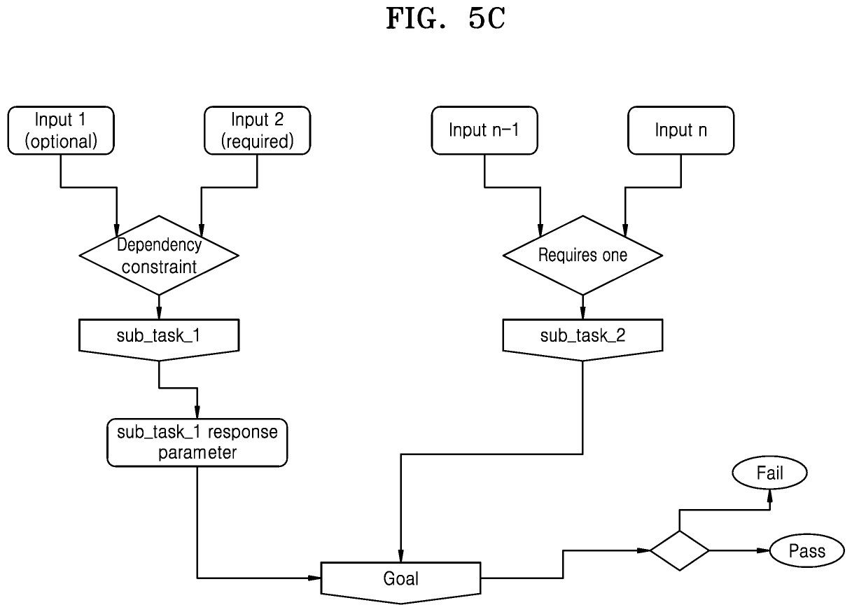

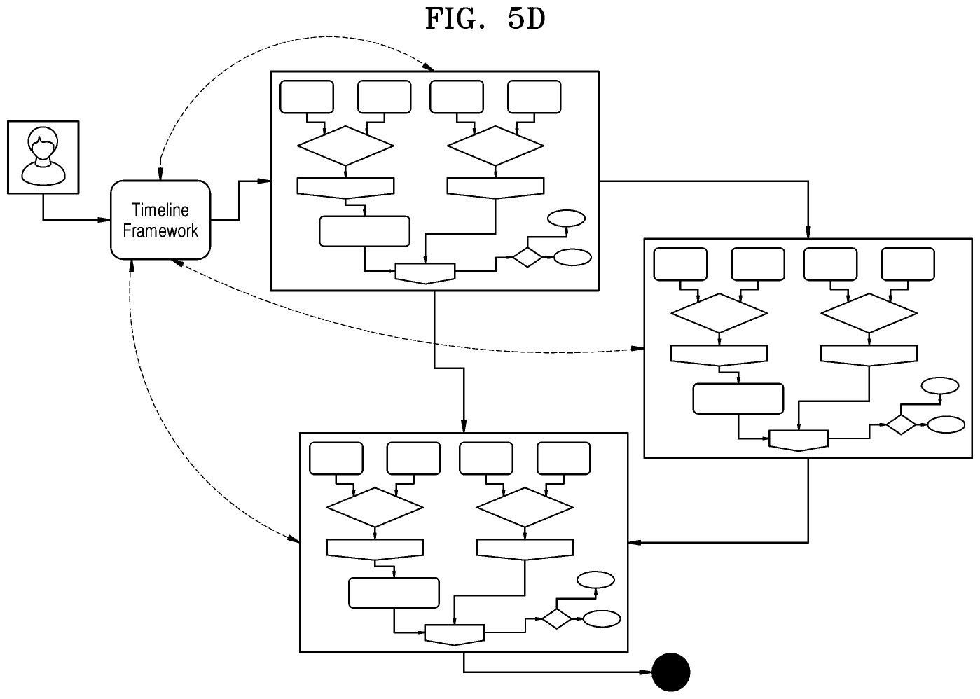

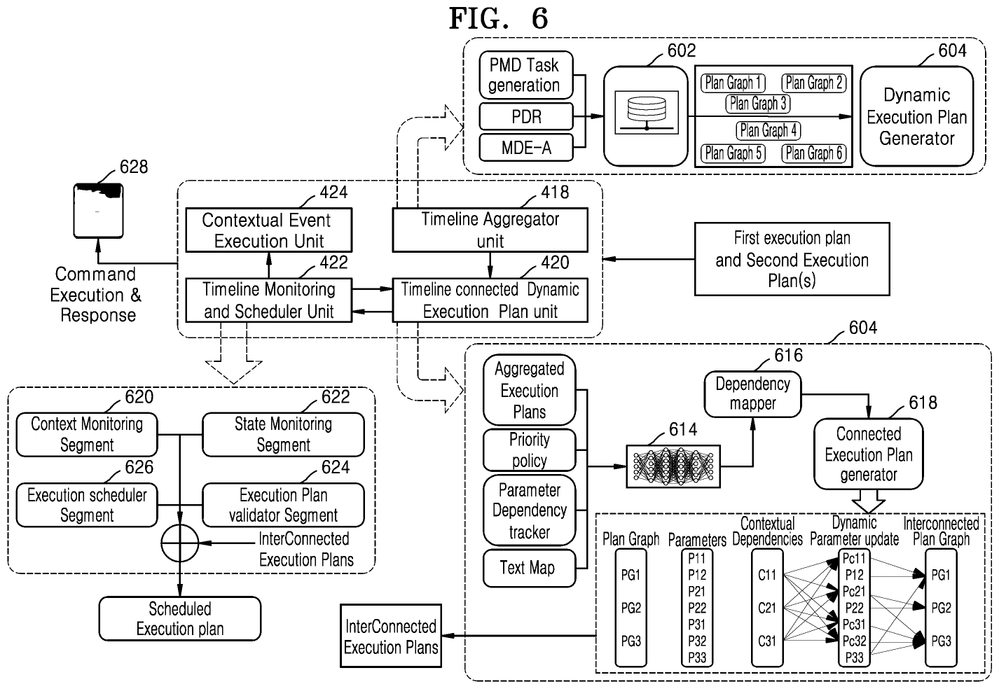

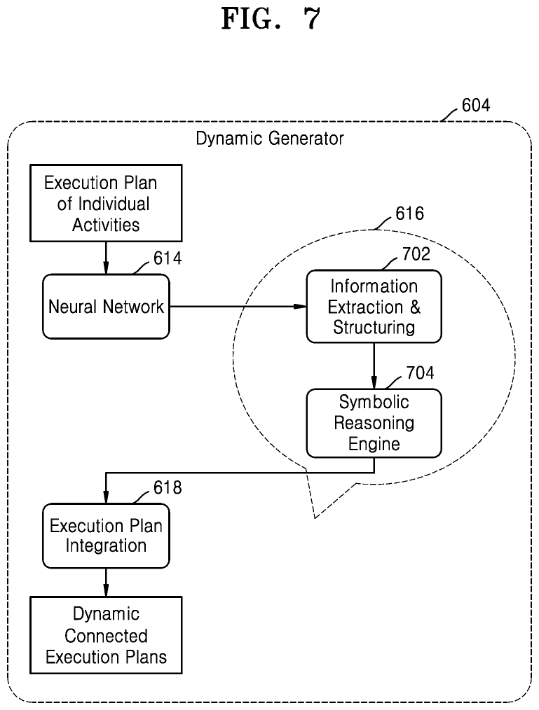

FIG. 4 illustrates an architecture of the system 204 for managing the execution plan for the device 202, in accordance with an embodiment of the present disclosure. FIGS. 5A and 5B illustrate the determination of a first context, a first execution plan, and one or more second execution plans by the system 204, in accordance with an embodiment of the present disclosure. FIGS. 5C and 5D illustrate the first execution plan and the one or more second execution plans, in accordance with an embodiment of the present disclosure. FIG. 6 illustrates the generation of a first timeline and a second timeline by the system 204, in accordance with an embodiment of the present disclosure. FIG. 7 illustrates the operation of a dynamic execution plan generator 604, in accordance with an embodiment of the present disclosure.

In an embodiment, FIG. 3 to FIG. 7 may be explained in conjunction with each other for the sake of brevity.

Referring to FIGS. 3, 4, and 5A, in an embodiment, the receiving module 314 may be configured to receive a first input indicating a voice command from the user. For example, the voice command may indicate to set an alarm for 5 AM to go to XYZ place. In another embodiment, the first input may be in a form of text or any other input modality, without departing from the scope of the present disclosure. The voice input may be obtained via the I/O interface 338 based on audio signals or audio data received via an input device such as an antenna, a microphone, an audio transceiver, a video device, a video transceiver, or other audio or video sources.

In an embodiment, the generating module 316 may be configured to generate a text format corresponding to the received first input by converting the received first input into the text format through at least one of a predetermined technique. The at least one of the predetermined technique may include, but is not limited to, an automated speech recognition technique 406. The automated speech recognition technique 406 may be defined as a technique that enables the system 204 to recognize and process the voice command by the user into the text format. The segregating module 318 may be configured to segregate the generated text format into a plurality of domains by classifying the generated text format through at least one of a predefined technique. The at least one of the pre-defined technique may include, but not limited to a natural level understanding (NLU) technique 404. The NLU technique 404 is defined as a technique which assists the 204 to understand, and interpret the text format/voice command in a contextually appropriate manner. In an embodiment, the plurality of domains may include, but is not limited to, search, reminders, alarms, for example, without departing from the scope of the present disclosure.

Based on the first input, the first context associated with the device 202 may be determined in an orchestrator unit 407 of the system 204. In an embodiment, the orchestrator unit 407 may be configured to provide a seamless integration of pieces of data sources, neural networks, different modules, for example, to determine the first context. The operation performed to determine the first context is explained in detail in the subsequent paragraphs.3

In an embodiment, the determining module 320 may be configured to determine the first context associated with the device 202 and a user intent, based on the first input. In an embodiment, the generating module 316 may be configured to generate word embeddings to the received first input based on a conversion of the segregated text format corresponding to the received first input into the word embeddings, via an embedding model. In an embodiment, the segregated text format corresponding to the received first input may be converted into the word embeddings by at least one predefined technique, for example, frequency based model technique, or word2Vec technique, without departing from the scope of the present disclosure. The identifying module 322 may be configured to identify a plurality of pieces of data corresponding to the received first input, based on a vector search of the generated word embeddings in a predefined vector database. In another embodiment, the identifying module 322 may be configured to identify the plurality of pieces of data, based on performing a plurality of search operations, for example, re-ranking, filtering, etc, without departing from the scope of the present disclosure. The plurality of pieces of data indicates a plurality of services associated with the first input. In an embodiment, an vector database of supported external services may include information regarding weather, or navigation, for example, without departing from the scope of the present disclosure.

The generating module 316 may be configured to generate a predetermined number of prioritized data, corresponding to the received first input, from the plurality of identified data. The generating module 316 may be configured to generate the predetermined number of prioritized data by re-ranking of the identified plurality of pieces of data based on the received first input, via re-ranking model. In an embodiment, the re-ranking of the identified plurality of pieces of data may be performed by, but is not limited to, various RAG techniques, without departing from the scope of the present disclosure. The predetermined number of prioritized data indicates data having the highest ranks when compared with remaining data from the plurality of pieces of data.

The providing module 324 may be configured to provide, from a plurality of external services providers, a plurality of external services upon requesting the plurality of external services based on the generated predetermined number of prioritized data, and the received first input. The predetermined number of prioritized data and the received first input may be provided to a neural network 506 of the system 204. In an embodiment, the neural network 506 may comprise large language model. The neural network 506 may process the predetermined number of prioritized data and the received first input and generate the plurality of external services corresponding to a user-tailored context, based on the processing. The providing module 324 may receive the plurality of external services. The providing module 324 may be configured to provide, from the plurality of external services providers, the plurality of external services upon requesting the plurality of external services. The plurality of external services may indicate a plurality of operations, for example, weather update, or navigation, associated with the first input.

The determining module 320 may be configured to determine the first context of the device 202 based on merging of the provided plurality of external services and a plurality of predetermined pieces of custom data, and multi-device environment (MDE) data in a context builder 510 of the orchestrator unit 407. The context builder 510 may fetch user custom data and MDE data from at least one vector database and collect the provided plurality of external services. The context builder 510 may use the provided plurality of external services, the user custom data, and the MDE data to generate the first context. In an embodiment, the determined first context may include a 360-degree analysis of the lifestyle of the user, around the first input. In an embodiment, the plurality of predetermined custom data may include, but is not limited to, information regarding alarm, events, tasks, a location, a usage pattern, or a time context, for example, without departing from the scope of the present disclosure. In an embodiment, the MDE data may include, but is not limited to, automatic appliances, service usage history, pattern, or relevance, for example, without departing from the scope of the present disclosure.

Based on the determined first context, the first execution plan and the one or more second execution plans may be generated in the orchestrator unit 407. In accordance with an embodiment of the present disclosure, an execution plan may be in the form of a plan graph. The operation performed to generate the first execution plan and the one or more second execution plans is explained in detail in the subsequent paragraphs with reference to FIGS. 3 to 5D.

Referring to FIGS. 3, 4, and 5B, in an embodiment, the generating module 316 may be configured to generate the first execution plan and the one or more second execution plans, based on the determined first context. The first execution plan may indicate one or more tasks to be executed in response to the determined first context of the first input. In an embodiment, the first execution plan may indicate one or more tasks to be executed according to a voice command of the first input. The one or more second execution plans may indicate one or more tasks to be executed in response to the determined first context of the first input. In an embodiment, the one or more second execution plans may indicate one or more tasks predicted to be executed within the determined first context of the first input.

In an embodiment, the merging module 326 may be configured to merge the determined first context and an outcome of a query corresponding to the received first input. In an embodiment, the query may be, but is not limited to, a cypher query, without departing from the scope of the present disclosure. The first input may be received by a cypher generator 514. A query may be generated by the cypher generator 514, based on the first input. The query may be provided to a natural language to a semantic network converter 516. A semantic network/knowledge graph may be configured to provide a plurality of predefined activities based on the query and the first input in the natural language to the semantic network converter 516. The plurality of predefined activities may be performed by the user, based on the first input and the query. The natural language to the semantic network converter 516 may be configured to process the query based on the plurality of predefined activities to generate the outcome of the query. The merging module 326 may be configured to merge the determined first context and the outcome of the query corresponding to the received first input. In an embodiment, the determined first context provides unstructured information and the outcome of the query provides a structured query without departing from the scope of the present disclosure. In an embodiment, the knowledge graph may enhance the operation of the system 204 by providing a structured yet flexible way to manage domain knowledge and user interactions. The knowledge graph provides permissible utterance sequences and relevant domain connections. For utterance “Set an alarm at 5 AM tomorrow to go to ABC place” can be like (:Alarm)-[:RELATED_TO]->(:Travel)”.

The merged determined first context, and the outcome of the query may be provided to the neural network 522 along with a plurality of instructions/prompts for further processing. In an embodiment, the merged determined first context, and the outcome of the query may contain a comprehensive user context, domain connections, relevant utterance sequence of the domains, for example. In an embodiment, the neural network 522 may be a timeline artificial intelligence multi-model, without departing from the scope of the present disclosure. In an embodiment, the neural network 522 may be configured to generate a plurality of future activities to be performed corresponding to the received first input based on the plurality of instructions/prompts. The plurality of future activities may be performed by a smart device of the user, or services, for example, thus, providing a holistic prediction of future activities.

The extracting module 328 may be configured to extract the plurality of future activities to be performed corresponding to the received first input and a plurality of categories corresponding to the plurality of predefined activities. The extracting module 328 may be configured to extract the plurality of future activities to be performed, and the plurality of categories, based on the merging, by a predefined technique. The predefined technique may include, but is not limited to, at least one of a fine-tuning technique, an adapter technique, and a rag technique. The generating module 316 may be configured to generate the first execution plan and the one or more second execution plans based on the extracted plurality of future activities and the plurality of categories.

In an embodiment, referring to FIG. 5C, the first execution plan and the one or more second execution plans may be particularly defined as one of, capability workflows or dependency resolutions workflows of any conversational device 202, a domain capability mapping with different instantiation strategies, input validations, error handling scenario implementations, planning for task execution by actions with input and output action definitions. The first execution plan, and the one or more second execution plans may also be defined as an endpoint connection to application programming interfaces (APIs) to external servers to accept the action inputs and return expected outputs, actions, input/output concepts, types to define dialogs, define selection rules, and input/output validation.

Referring to FIG. 5D, the first execution plan and the one or more second execution plans may be created once after the first input as captured are to be executed. The first execution plan and the one or more second execution plans may be interdependent where the current execution plan might have a dependency on the execution plan resulting from prior utterance/use case. As the use cases may be modified based on the execution results and adaptive contextual information, the one or more second execution plans may be also dynamically generated to incorporate into the already existing first execution plan. The first execution plan and the one or more second execution plans generated are adaptive and contextual.

In an embodiment, referring to FIGS. 4 and 5B, the segregating module 318 along with a response optimizer 524, may be configured to segregate the first execution plan and the one or more second execution plans into the plurality of pre-determined groups. The plurality of pre-determined groups may include a proactive multi-domain task group, a personalized dynamic recommendation group, and a multi-device assistance group. This configuration tailored an output format, e.g., the first execution plan and the one or more second execution plans for seamless integration. In an embodiment, the proactive multi-domain task group may include tasks/future activities which may be prompted by the system 204 to the user for execution. Herein, the trigger may be from the system 204 and not the user. In an embodiment, the personalized dynamic recommendation group may indicate recommendations which may be shown as hints to the user, and further the user can decide to trigger the operations. In an embodiment, the multi-device assistance group may indicate activities which may be related to connected smart home devices.

Referring to FIGS. 3, 4, and 6, in an embodiment, the generating module 316 may be configured to generate the first timeline connecting the first execution plan and the one or more second execution plans. The operations performed to generate the first timeline may be performed in a timeline aggregator unit 418 of the system 204, without departing from the scope of the present disclosure.

In an embodiment, the aggregating module 330 may be configured to aggregate the first execution plan and the one or more second execution plans, after segregating the first execution plan and the one or more second execution plans. The aggregating module 330 may be configured to aggregate the first execution plan and the one or more second execution plans. The aggregating module 330 may be configured to aggregate, by an aggregator cache 602 based on a plurality of parameters. The plurality of parameters may include a location, a time, type of the device 202, or a state of the device 202, for example. The transmitting module 331 may be configured to transmit the aggregated first execution planand the one or more second execution plansto the dynamic execution plan generator 604, provided in a timeline connected dynamic execution plan unit 420 of the system 204, in a sequential order. The aggregation procedure caters to all the conditions such as where the single user intent is broken into multi-intent execution system 204.

The processing module 332 may be configured to process the transmitted first execution plan and the one or more second execution plans along with a plurality of predetermined factors by a neural network 614 in the dynamic execution plan generator 604. The plurality of predetermined factors may include, but is not limited to, a priority policy, a parameter dependency tracker, and a text map. In an embodiment, the neural network 614 may be configured to process and extract meaningful information from individual execution plans of activities. The neural network 614 may employ a plurality of different techniques, for example, tokenization, named entity recognition, and dependency parsing to process and interpret the transmitted first execution plan and the one or more second execution plans. This network 614 essentially bridges the gap between raw data and actionable insights, aiding in efficient decision-making and strategic planning.

Referring to FIGS. 6 and 7, the first execution plan and the one or more second execution plans along with the plurality of predetermined factors, after processing by the neural network 614, may be transmitted to a dependency mapper 616 for further operation. The dependency mapper 616 having an information extraction structuring unit 702, and a symbolic reasoning engine 704, may be configured to analyze interdependence between the first execution plan and the one or more second execution plans. The information extraction structuring unit 702 may be configured to extract and identify information such as actions, objects, and entities from the first execution plan and the one or more second execution plans.

The information extraction structuring unit 702 may be configured to structure the extracted information in a way that facilitates reasoning and understanding of each of the first execution plan and the one or more second execution plans. For instance, when fed with a ‘node’ containing actions such as ‘navigate’ or ‘find’, along with associated locations or objects, it returns an organized ‘activity’ array, attributing the actions as ‘type’ and designating corresponding locations or targets.

The symbolic reasoning engine 704 may be configured to establish the connection between the first execution plan and the one or more second execution plans. The symbolic reasoning engine 704 may be a neuro-symbolic artificial intelligence (AI) module that applies various rules to structured data. This engine 704 receives structured data from the information extraction structuring unit 702, and applies rules, for example, Temporal Dependencies, Causal Relationships, and Contextual Grouping to find relations between the first execution plan and the one or more second execution plans. This engine 704 transforms the input into a more refined output by identifying connections based on the applied rules. This engine 704 enables the system 204 to understand the context and dependencies between the first execution plan and the one or more second execution plans, thereby enabling more efficient and logical decision-making processes.

The first execution plan and the one or more second execution plans may be transmitted to a connected execution plan generator 618. The connected execution plan generator 618 may take structured data from the symbolic reasoning engine 704 and integrate the first execution plan and the one or more second execution plans into a single connected execution plan. This generator 618 uses the relationships and connections among activities to generate this unified plan. The input to this generator 618 includes ‘activities’ along with ‘rules applied’, and thus, outputs the interconnected first execution plan and the one or more second execution plans. Thus, from the connected execution plan generator 618, the generating module 316 may be configured to generate the interconnected first execution plan and the one or more second execution plans based on the scheduler flag and the first timeline connecting the interconnected first execution plan and the one or more second execution plans.

In an embodiment, the segregating module 318 may be configured to segregate the interconnected first execution plan and one or more second execution plans based on a plurality of predetermined segments. The plurality of predetermined segments may include a context monitoring service segment/context monitoring segment 620, a state monitoring service segment/state monitoring segment 622, an execution plan validator segment 624, and an execution scheduler segment 626. In an embodiment, the context monitoring service segment 620 may facilitate runtime contextual data or continuous observation and analyzation of a context surrounding associated with the interconnected first execution plan and one or more second execution plans. The state monitoring service segment 622 may facilitate continuous observation and analyzation of the status of the interconnected first execution plan and one or more second execution plans. The execution plan validator segment 624 may facilitate the correctness of the interconnected first execution plan and one or more second execution plans. The execution scheduler segment 626 may facilitate the scheduling of the interconnected first execution plan and one or more second execution plans. In case of any change/updation in the interconnected first execution plan and one or more second execution plans, the change/updation may be reverted to the dynamic execution plan generator 604 for further processing, and the execution scheduler segment 626 may indicate scheduling of the change/updation.

In an embodiment, the segregation of the interconnected first execution plan and one or more second execution plans may be performed in a timeline monitoring and scheduler unit 422 of the system 204, without departing from the scope of the present disclosure. In an embodiment, the timeline monitoring and scheduler 422 may ensure tracking events, tasks, or plans over time and manage execution schedules, without departing from the scope of the present disclosure.

The analyzing module 334 may be configured to analyze a validation of the segregated interconnected first execution plan and the one or more second execution plans based on a real-time status of the user and the determined first context. In an embodiment, the analyzing of the validation of the segregated interconnected first execution plan and the one or more second execution plans may be performed in a contextual event execution unit 424 of the system 204, without departing from the scope of the present disclosure.

The executing module 335 may be configured to execute the segregated interconnected first execution plan and one or more second execution plans on at least one user equipment 628. The executing module 335 may be configured to execute, when the segregated interconnected first execution plan and one or more second execution plans are validated. The segregated interconnected first execution plan and one or more second execution plans may be marked as expired the segregated interconnected first execution plan and one or more second execution plans are invalid. The at least one user equipment 628 may include, but is not limited to, a smartphone, a laptop, a watch, wearables, hearables, television, or refrigerators, for example, without departing from the scope of the present disclosure. The above-mentioned operations may be performed in a contextual event execution unit 424 of the system 204. The contextual event execution unit 424 may facilitate interaction with different user equipment to execute the segregated interconnected first execution plan and one or more second execution plans on at least one user equipment 628 based on the first timeline, schedule, for example.

The contextual event execution unit 424 may transmit information to a user equipment 628 of the user to cause the user equipment 628 to execute at least one task from among the first execution plan, the updated execution plan, or the one or more second execution plans. One or more tasks or one or more execution plans based on the first timeline may be executed on at least one user equipment 628.

In an embodiment, the detecting module 336 may be configured to detect a change from the first context of the device 202 based on the generated first timeline and at least one of a second context of the device 202 or a second context of the user. In an embodiment, the detecting module 336 may be configured to detect from the determined first context of the device 202. The detecting module 336 may be configured to detect the change based on correlating the generated first timeline and the second context of the device 202 and/or the second context of the user, via a context monitoring service technique. The detecting module 336 may be configured to detect a change of a plurality of variables associated with the generated first execution plan and the one or more second execution plans. The detecting module 336 may be configured to detect the change based on correlating the generated first timeline and the second context of the device 202 and/or the second context of the user, via a state monitoring service technique or an execution plan validator technique. The plurality of variables may include an initial state of the at least one of user equipment 628, a type of the at least one of the user equipment 628 and a plan provided in the generated first execution plan and the one or more second execution plans.

In an embodiment, the generating module 316 may further be configured to generate an updated execution plan based on the detected change. The updated execution plan may indicates one or more third tasks to be executed in response to the detected change. The updated execution plan may indicates one or more third tasks to be executed in response to the second context of the device 202 and/or the second context of the user. In an embodiment, the updated execution plan indicates an extension of the one or more second execution plans or a replacement of the one or more second execution plans.

In an embodiment, the generating module 316 may further be configured to generate a second timeline by modifying or updating the first timeline based on the updated execution plan. In an embodiment, the second timeline may be generated based on modifying or updating at least one of the first execution plan or the one or more second execution plans with the updated execution plan. The second timeline may be generated based on modifying or updating the one or more second execution plans connected to the first execution plan with the updated execution plan. The second timeline may be generated based on connecting the updated execution plan with the execution plan and the one or more second execution plan. In an embodiment, the execution plan may be the first execution plan or already generated execution plan, without departing from the scope of the present disclosure.

The second timeline may be output to the user via the Input/Output (I/O) interface 338 via a display or a speaker, for example. The output via the display may include a graphical depiction of the second timeline. The output via the speaker may include audio generated based on a text-to-speech engine or model that produces synthetic speech audio based on a text representation of the second timeline. One or more tasks or one or more execution plans based on the second timeline may be executed on at least one user equipment 628.

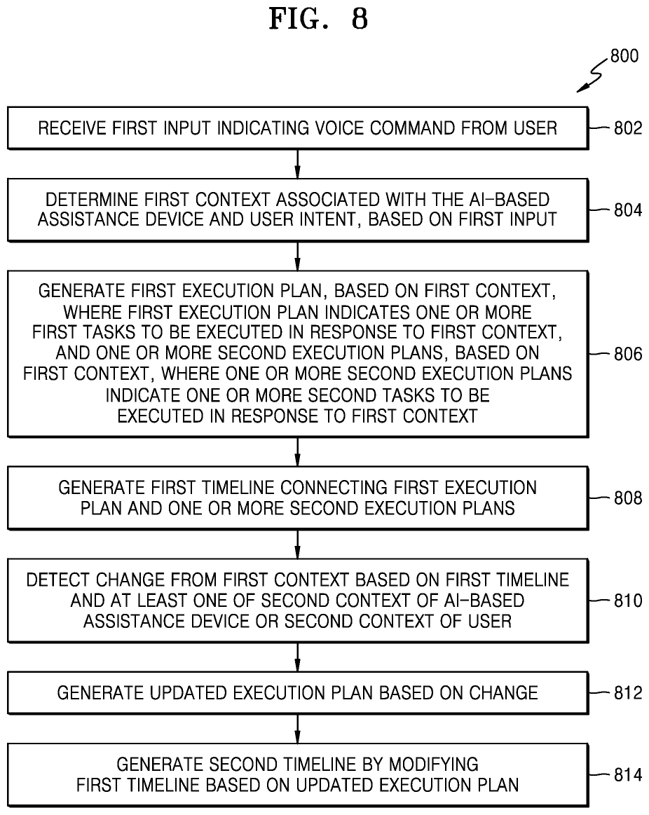

FIG. 8 illustrates a flowchart depicting a method 800 for managing the execution plan for the device 202, in accordance with an embodiment of the present disclosure. The method 800 includes a series of operations shown at step 802 through step 814 of FIG. 8. The method 800 may be performed by the system 204 in conjunction with modules 312, the details of which are explained in conjunction with FIGS. 3 to 7, and the same are not repeated here for the sake of brevity in the present disclosure. The method 800 begins at step 802.

At step 802, the method 800 includes receiving the first input indicating the voice command from the user.

The method 800 includes generating the text format corresponding to the received first input by converting the received first input into the text format through at least one of the predetermined technique. The at least one of the predetermined technique may be via the automated speech recognition (ASR) model 406. The method 800 includes segregating the generated text format into the plurality of domains by classifying the generated text format through at least one of the predefined technique. The at least one of the pre-defined technique may be via the natural level understanding (NLU) model 404.

At step 804, the method 800 includes determining the first context associated with the AI based assistance device 202 and the user intent, based on the first input. The method 800 includes generating word embeddings corresponding to the received first input based on the conversion of the segregated text format corresponding to the received first input into the word embeddings. The method 800 includes identifying the plurality of pieces of data corresponding to the received first input, based on the vector search of the generated word embeddings in the predefined vector database. The plurality of pieces of data may indicate the plurality of services associated with the first input. The method 800 includes generating the predetermined number of prioritized data, corresponding to the received first input, from the plurality of identified data by the re-ranking of the identified plurality of pieces of data based on the received first input. The predetermined number of prioritized data may indicate data having highest ranks when compared with remaining data from the plurality of pieces of data. The method 800 includes providing, from the plurality of external services providers, the plurality of external services upon requesting the plurality of external services based on the generated predetermined number of prioritized data, and the received first input. The plurality of external services may indicate the plurality of operations associated with the first input. The method 800 includes determining the first context of the device 202, based on merging of the provided plurality of external services and the plurality of predetermined pieces of custom data, and multi-device environment (MDE) data.

At step 806, the method 800 includes generating the first execution plan, based on the determined first context and the one or more second execution plans, based on the determined first context. The first execution plan indicates one or more tasks to be executed in response to the determined first context of the first input. The one or more second execution plans may indicate one or more tasks to be executed in response to the determined first context of the first input.

The method 800 includes merging the determined first context and the outcome of the query corresponding to the received first input. The method 800 includes extracting the plurality of future activities to be performed corresponding to the received first input and the plurality of categories corresponding to the plurality of predefined activities, by the predefined technique, based on the merging. The predefined technique may include at least one of the fine-tuning technique, the adapter technique, and the rag technique. The method 800 includes generating the first execution plan and the one or more second execution plans based on the extracted plurality of future activities and the plurality of categories.

The method 800 includes segregating the first execution plan and the one or more second execution plans into the plurality of pre-determined groups. The plurality of pre-determined groups may include the proactive multi-domain task group, the personalized dynamic recommendation group, and the multi-device assistance group.

At step 808, the method 800 includes generating the first timeline connecting the first execution plan and the one or more second execution plans.

The method 800 includes aggregating the first execution plan and the one or more second execution plans, after segregating the first execution plan and the one or more second execution plans, by the aggregator cache 602 based on the plurality of parameters. The plurality of parameters may include the location and time. The method 800 includes transmitting the aggregated the first execution plan and the one or more second execution plans to the dynamic execution plan generator 604 in the sequential order. The method 800 includes processing the transmitted first execution plan and one or more second execution plans along with the plurality of predetermined factors by the neural network 614 in the dynamic execution plan generator 604. The plurality of predetermined factors may include the priority policy, the parameter dependency tracker, and the text map. The method 800 includes generating the interconnected first execution plan and one or more second execution plans and the first timeline connecting the interconnected first execution plan and one or more second execution plans.

The method 800 includes segregating the interconnected first execution plan and one or more second execution plans based on the plurality of predetermined segments. The plurality of predetermined segments may include the context monitoring service segment 620, the state monitoring service segment 622, the execution plan validator segment 624, and the execution scheduler segment 626. The method 800 includes analyzing the validation of the segregated interconnected first execution plan and one or more second execution plans based on the real-time status of the user and the determined first context. The method 800 includes executing the segregated interconnected first execution plan and one or more second execution plans on at least one of the user equipment 628, when the segregated interconnected first execution plan and one or more second execution plans are validated. The at least one of the user equipment 628 may include the smartphone, laptop, and watch.

At step 810, the method 800 includes detecting the change from the determined first context of the device 202 based on the generated first timeline and at least one of the second context of the device 202 or the second context of the user.

The method 800 includes detecting the change from the determined first context of the device 202 based on correlating the generated first timeline and the second context of the device 202 and/or the second context of the user, via the context monitoring service technique. The method 800 includes detecting the change of the plurality of variables associated with the generated first execution plan and the one or more second execution plans based on correlating the generated first timeline and the second context of the device 202 and/or the second context of the user, via the state monitoring service technique or the execution plan validator technique. The plurality of variables may include the initial state of at least one of the user equipment 628, the type of at least one of the user equipment 628, and the plan provided in the generated first execution plan and the one or more second execution plans.

At step 812, the method 800 includes generating the updated execution plan based on the detected change. The updated execution plan may indicates one or more third tasks to be executed in response to the detected change. The updated execution plan may indicates one or more third tasks to be executed in response to the second context of the device 202 and/or the second context of the user. In an embodiment, the updated execution plan may indicate an extensions of the one or more second execution plans or a replacement of the one or more second execution plans.

At step 814, the method 800 includes generating the second timeline by modifying or updating the first timeline based on the updated execution plan. In an embodiment, the second timeline may be generated based on modifying or updating at least one of the first execution plan or the one or more second execution plans with the updated execution plan. The second timeline may be generated based on modifying or updating the one or more second execution plans connected to the first execution plan with the updated execution plan. The second timeline may be generated based on connecting the updated execution plan with the first execution plan and the one or more second execution plans.

The method 800 may further include transmitting information to a user equipment 628 of the user to cause the user equipment 628 to execute at least one task from among the first execution plan, the updated execution plan, and the one or more second execution plans.

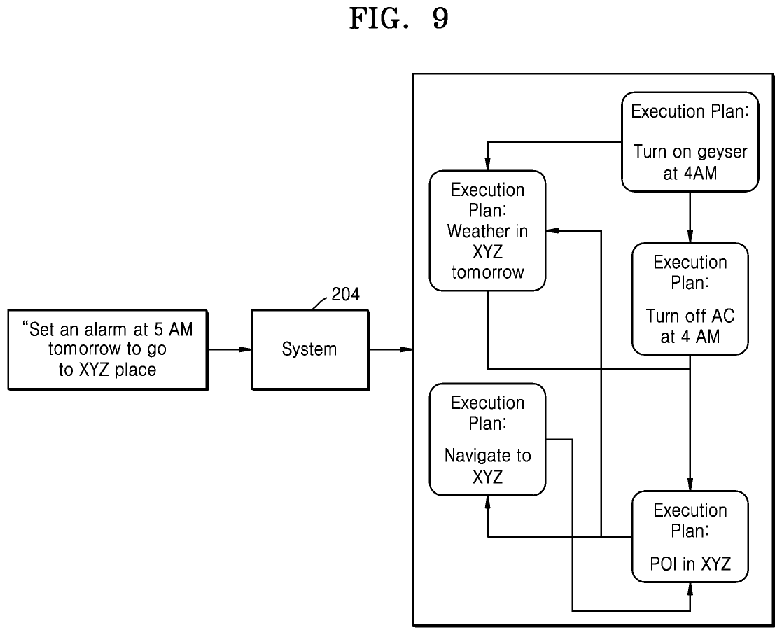

FIG. 9 illustrates an example timeline representation of a use case scenario implementation of the system 204 and the method 800 to generate the first execution plan based on the first input from the user, in accordance with an embodiment of the present disclosure. As depicted in the figure, the user provides a command e.g., “a voice input for setting an alarm at 5 AM tomorrow to go to XYZ place”. Then the method 800 and system 204 as disclosed herein determine the context from the first input and generate a timeline having various tasks and recommendations, as shown in FIG. 9, to assist the user without any further input or command from the user. The method 800 and the system 204 may consider various dynamics associated with the user command, for example, if it's a heavy rainy day tomorrow, then the method 800 and the system 204 may also include suggesting to the user if he/she wants to postpone the trip to XYZ place. In one embodiment, method 800 and the system 204 as disclosed herein may generate the tasks and the recommendations based on usage patterns and dynamics such as, smart geyser and Air Conditioner (AC) operations, for example.

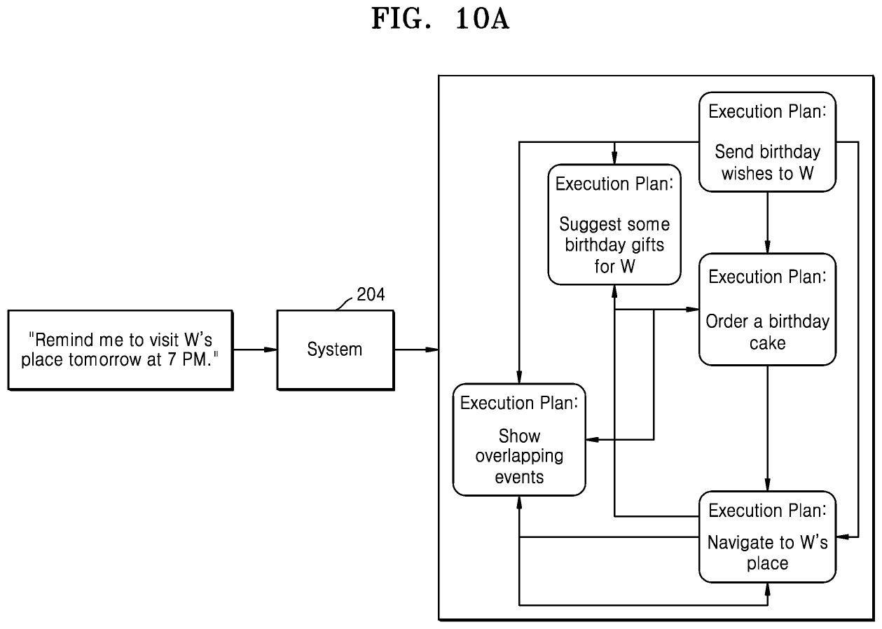

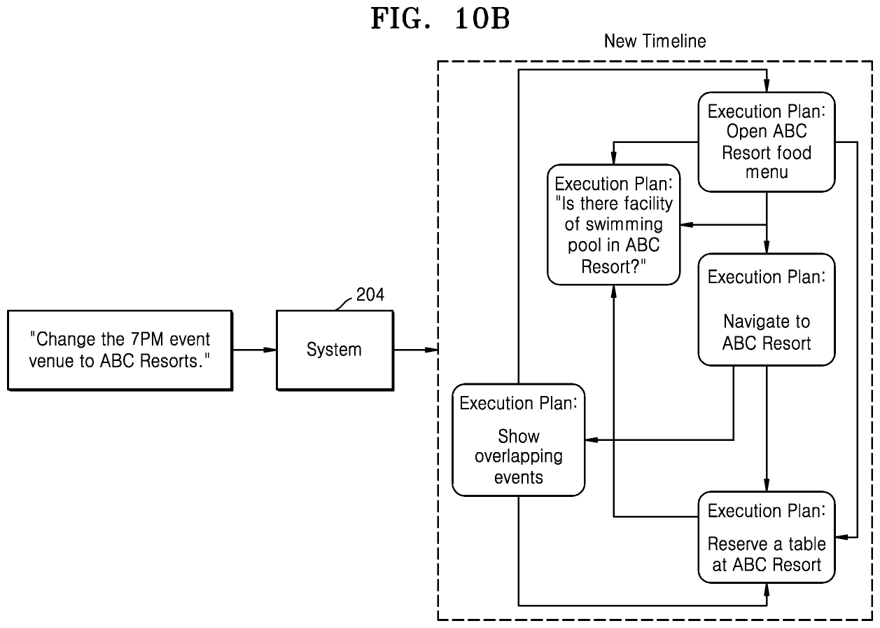

FIGS. 10A and 10B illustrate another example timeline representation of a use-case scenario implementation of method 800 and the system 204 to dynamically generate task recommendations based on the first input from the user and execute tasks based on dynamically generated task recommendations, in accordance with an embodiment of the present disclosure. As depicted in the figure, the user provides a command e.g., “Remind me to visit W's place tomorrow at 7 PM”. Then the method 800 and the system 204 as disclosed herein determine the context from the first input and generate a timeline having various tasks and recommendations, as shown in FIG. 10A to assist the user without any further input or command from the user. The method 800 and the system 204 may generate the timeline based on the data associated with the user to plan the day accordingly by deriving the context that it is W's birthday tomorrow based on retrieving all possible info and events related to W, like birthday, or anniversary, for example, from the various sources of pieces of data. The method 800 and system 204 as disclosed herein may also consider overlapping events and schedules surrounding the timeframe of the first input and intent considering such overlapping events. As shown in FIG. 10B, in a scenario, a new event such as a change in venue is detected e.g., “Change the 7 PM event venue to ABC Resorts”. The method 800 and the system 204 as disclosed dynamically adjust the timeline in accordance with the change to assist the user without any further input required from the user. The timeline may also take into account any preplanned or overlapping events such as meetings, which may be identified based on the data associated with the user from various sources and devices while generating the timeline and suggestions for the user. The provided illustration is intended for informative purposes, and any interpretation or application of the results should consider the context and specifics of the test scenario.

The present disclosure ensures a technical advancement in the field of assistive technology and recommendation systems. The technical advantages of the present disclosure approach lie in its ability to intelligently predict a range of tasks that users would like to undertake or perform, thus managing the execution plan for the device 202. This involves a Multi-Intent, Multi-Domain, Multi-Device dynamic generative first execution plan and the one or more second execution plans & Timeline Creation, which generates a timeline of tasks, recommendations, and assistive commands tailored to the user's needs and context. These generative timeline branches adapt and expand as activities progress, ensuring a comprehensive approach to task management. The system 204 and the method 800 as disclosed ensure a dynamically connected first execution plan, and the one or more second execution plans based on a contextual dependency, a priority, a sequence of execution occurrence, thus ensuring the prediction of the plurality of future activities based on the user input, providing personalized and proactive user experience. Moreover, the system 204 dynamically adjusts/modifies tasks and schedules based on correlation information in the Multi-Device Environment (MDE), and incoming timeline activities, ensuring adaptability and efficiency. This runtime adaptive timeline generation considers user scenarios and preferences, resulting in a personalized and proactive user experience. Overall, this 360 Degree AI Framework manages the execution plan for the device 202, offers end-to-end support for users, considering all angles and dynamics, and thus, providing customized proactiveness, assistance, and suggestions throughout the user journey,

The prior known solutions do not consider surrounding factors relating to the user such as the intent of the user, the domain of the event, and data from multiple devices to adapt and expand as activities progress or are executed. These approaches fail to sense, adapt, and execute based on correlations between different tasks and activities that the user may perform or is required to perform according to the user preferences or the change in a particular event which is overcome by the system 204 and the method 800 as disclosed in the present disclosure.

According to an embodiment of the disclosure, a method for managing an execution plan for an artificial intelligence (AI)-based assistance device may include receiving a first input, via a microphone, indicating a voice command from a user. The method may include determining a first context associated with the AI-based assistance device and a user intent, based on the first input. The method may include generating a first execution plan, based on the first context, wherein the first execution plan indicates one or more first tasks to be executed in response to the first context, and one or more second execution plans, based on the first context, wherein the one or more second execution plans indicate one or more second tasks to be executed in response to the first context. The method may include generating a first timeline connecting the first execution plan and the one or more second execution plans. The method may include detecting a change from the first context based on the first timeline and at least one of a second context of the AI-based assistance device or a second context of the user. The method may include generating an updated execution plan based on the change. The method may include generating a second timeline by modifying the first timeline based on the updated execution plan.

According to an embodiment of the disclosure, prior to the determining the first context, the method may include generating a text format corresponding to the first input by converting the first input into text based on an automated speech recognition (ASR) model. The method may include segregating the text format into a plurality of domains by classifying the text format based on a natural level understanding (NLU) model.

According to an embodiment of the disclosure, the determining of the first context may include generating word embeddings corresponding to the first input based on a conversion of a segregated text format corresponding to the first input into the word embeddings. The determining of the first context may include identifying a plurality of pieces of data corresponding to the first input, based on a vector search of the word embeddings in a predefined vector database, wherein the plurality of pieces of data indicates a plurality of services associated with the first input. The determining of the first context may include generating a predetermined number of prioritized pieces of data, corresponding to the first input, from the plurality of pieces of data by re-ranking the plurality of pieces of data based on the first input, wherein the predetermined number of prioritized pieces of data indicate one or more pieces of data having highest ranks compared with remaining pieces of data from among the plurality of pieces of data. The determining of the first context may include providing, from a plurality of external services provider, information corresponding to a plurality of external services upon requesting the plurality of external services based on the predetermined number of prioritized pieces of data, and the first input, wherein the information corresponding to the plurality of external services indicates a plurality of operations associated with the first input. The determining of the first context may include determining the first context, based on merging the information corresponding to the plurality of external services and a plurality of predetermined pieces of custom data, and multi-device environment (MDE) data.

According to an embodiment of the disclosure, the generating of the first execution plan and the one or more second execution plans may include merging the first context and an outcome of a query corresponding to the first input. The generating of the first execution plan and the one or more second execution plans may include extracting activity information corresponding to a plurality of future activities to be performed, based on at least one of a fine-tuning technique, an adapter technique or a rag technique, wherein the activity information corresponds to the first input and a plurality of categories of predefined activities. The generating of the first execution plan and the one or more second execution plans may include and generating the first execution plan and the one or more second execution plans based on the activity information and the plurality of categories.

According to an embodiment of the disclosure, the method may further include segregating the first execution plan and the one or more second execution plans into a plurality of pre-determined groups. The plurality of pre-determined groups may include a proactive multi domain task group, a personalized dynamic recommendation group, and multi-device assistance group.

According to an embodiment of the disclosure, the generating of the first timeline may include aggregating the first execution plan and the one or more second execution plans, after segregating the first execution plan and the one or more second execution plans into a plurality of pre-determined groups, via an aggregator cache based on a plurality of parameters including a location, and a time. The generating of the first timeline may include transmitting the aggregated first execution plan and the one or more second execution plans to a dynamic execution plan generator in a sequential order.

According to an embodiment of the disclosure, the generating of the first timeline may include processing the aggregated first execution plan and the one or more second execution plans, via a neural network of the dynamic execution plan generator, based on a plurality of predetermined factors including a priority policy, a parameter dependency tracker, and a text map. The generating of the first timeline may include generating an interconnected first execution plan and the one or more second execution plans and the first timeline connecting the interconnected first execution plan and the one or more second execution plans.

According to an embodiment of the disclosure, the method may include segregating the interconnected first execution plan and the one or more second execution plans based on a plurality of predetermined segments, wherein the plurality of predetermined segments may include a context monitoring service segment, a state monitoring service segment, an execution plan validator segment, and an execution scheduler segment. The method may include analyzing a validation of the segregated interconnected first execution plan and the one or more second execution plans based on a real-time status of the user and the first context. The method may include transmitting information to a user equipment of the user to cause the user equipment to execute the segregated interconnected first execution plan and the one or more second execution plans on the user equipment, based on the segregated interconnected first execution plan and the one or more second execution plans being validated.

According to an embodiment of the disclosure, the detecting of the change may include detecting the change from the first context, based on correlating the first timeline with at least one of the second context or the second context of the user, via a context monitoring service. The detecting of the change may include detecting a change of a plurality of variables associated with the first execution plan and the one or more second execution plans, based on correlating the first timeline with at least one of the second context or the second context of the user, via a state monitoring service or an execution plan validator. The plurality of variables may include an initial state of at least one of user equipment, a type of at least one of the user equipment, and a plan provided in the first execution plan and at least one of the one or more second execution plans.

According to an embodiment of the disclosure, the updated execution plan may indicate an extension of the one or more second execution plans or a replacement of the one or more second execution plans.

According to an embodiment of the disclosure, a system for managing an execution plan for an artificial intelligence (AI)-based assistance device comprising memory storing instructions and at least one processor in communication with the memory is provided. The instructions, when executed by the at least one processor, may cause the system to receive a first input, via a microphone, indicating a voice command from a user. The instructions, when executed by the at least one processor, may cause the system to determine a first context associated with the AI-based assistance device and a user intent, based on the first input. The instructions, when executed by the at least one processor, may cause the system to generate a first execution plan, based on the first context, wherein the first execution plan indicates one or more first tasks to be executed in response to the first context, and one or more second execution plans, based on the first context, wherein the one or more second execution plans indicate one or more second tasks to be executed as response to the first context. The instructions, when executed by the at least one processor, may cause the system to generate a first timeline connecting the first execution plan and the one or more second execution plans. The instructions, when executed by the at least one processor, may cause the system to detect a change from the first context based on the first timeline and at least one of a second context of the AI-based assistance device or a second context of the user. The instructions, when executed by the at least one processor, may cause the system to generate an updated execution plan based on the change. The instructions, when executed by the at least one processor, may cause the system to generate a second timeline by modifying the first timeline based on the updated execution plan.

According to an embodiment of the disclosure, the instructions, when executed by the at least one processor, may cause the system to generate a text format corresponding to the first input by converting the first input into text based on an automated speech recognition (ASR) model. The instructions, when executed by the at least one processor, may cause the system to segregate the text format into a plurality of domains by classifying the text format based on a natural level understanding (NLU) model.

According to an embodiment of the disclosure, the instructions, when executed by the at least one processor, may cause the system to generate word embeddings corresponding to the first input based on a conversion of a segregated text format corresponding to the first input into the word embeddings. The instructions, when executed by the at least one processor, may cause the system to identify a plurality of pieces of data corresponding to the first input, based on a vector search of the word embeddings in a predefined vector database, wherein the plurality of pieces of data indicates a plurality of services associated with the first input. The instructions, when executed by the at least one processor, may cause the system to generate a predetermined number of prioritized pieces of data, corresponding to the first input, from the plurality of pieces of data by re-ranking the plurality of pieces of data based on the first input, wherein the predetermined number of prioritized pieces of data indicate one or more pieces of data having highest ranks compared with remaining pieces of data from among the plurality of pieces data. The instructions, when executed by the at least one processor, may cause the system to provide, from a plurality of external services provider, information corresponding to a plurality of external services upon requesting the plurality of external services based on the predetermined number of prioritized pieces of data, and the first input, wherein the information corresponding to the plurality of external services indicates a plurality of operations associated with the first input. The instructions, when executed by the at least one processor, may cause the system to determine the first context, based on merging the information corresponding to the plurality of external services and a plurality of predetermined pieces of custom data, and multi-device environment (MDE) data.

According to an embodiment of the disclosure, the instructions, when executed by the at least one processor, may cause the system to merge the first context and an outcome of a query corresponding to the first input. The instructions, when executed by the at least one processor, may cause the system to extract activity information corresponding to a plurality of future activities to be performed, based on at least one of a fine-tuning technique, an adapter technique or a rag technique, wherein the activity information corresponds to the first input and a plurality of categories of predefined activities. The instructions, when executed by the at least one processor, may cause the system to generate the first execution plan and the one or more second execution plans based on the activity information and the plurality of categories.

According to an embodiment of the disclosure, the instructions, when executed by the at least one processor, may further cause the system to segregate the first execution plan and the one or more second execution plans into a plurality of pre-determined groups. The plurality of pre-determined groups may include a proactive multi domain task group, a personalized dynamic recommendation group, and a multi-device assistance group.

According to an embodiment of the disclosure, the instructions, when executed by the at least one processor, may cause the system to aggregate the first execution plan and the one or more second execution plans, after segregating the first execution plan and the one or more second execution plans into a plurality of pre-determined groups, via an aggregator cache based on a plurality of parameters including a location, and a time. The instructions, when executed by the at least one processor, may cause the system to transmit the aggregated first execution plan and the one or more second execution plans to a dynamic execution plan generator in a sequential order.

According to an embodiment of the disclosure, the instructions, when executed by the at least one processor, may cause the system to process the aggregated first execution plan and the one or more second execution plans, via a neural network of the dynamic execution plan generator, based on a plurality of predetermined factors including a priority policy, a parameter dependency tracker, and a text map. The instructions, when executed by the at least one processor, may cause the system to generate an interconnected first execution plan and the one or more second execution plans and the first timeline connecting the interconnected first execution plan and the one or more second execution plans.

According to an embodiment of the disclosure, the instructions, when executed by the at least one processor, may further cause the system to segregate the interconnected first execution plan and the one or more second execution plans based on a plurality of predetermined segments, wherein the plurality of predetermined segments may include a context monitoring service segment, a state monitoring service segment, an execution plan validator segment, and an execution scheduler segment. The instructions, when executed by the at least one processor, may cause the system to analyze a validation of the segregated interconnected first execution plan and the one or more second execution plans based on a real-time status of the user and the first context. The instructions, when executed by the at least one processor, may cause the system to transmit information to a user equipment of the user to cause the user equipment to execute the segregated interconnected first execution plan and the one or more second execution plans on the user equipment, based on the segregated interconnected first execution plan and the one or more second execution plans being validated.

According to an embodiment of the disclosure, the instructions, when executed by the at least one processor, may cause the system to detect the change from the first context, based on correlating the first timeline with at least one of the second context or the second context of the user, via a context monitoring service. The instructions, when executed by the at least one processor, may cause the system to detect a change of a plurality of variables associated with the first execution plan and the one or more second execution plans based on correlating the first timeline with at least one of the second context or the second context of the user, via a state monitoring service or an execution plan validator. The plurality of variables may include an initial state of at least one of user equipment, a type of at least one of the user equipment, and a plan provided in the first execution plan and at least one of the one or more second execution plans.

According to an embodiment of the disclosure, the updated execution plan may indicate one of an extension of the one or more second execution plans and replacement of the one or more second execution plans.

According to an embodiment of the disclosure, a non-transitory computer-readable storage medium storing instructions is provided. The instructions may be executed by at least one processor, cause the at least one processor to receive a first input, via a microphone, indicating a voice command from a user. The instructions, when executed by the at least one processor, may cause the at least one processor to determine a first context associated with the AI-based assistance device and a user intent, based on the first input. The instructions, when executed by the at least one processor, may cause the at least one processor to generate a first execution plan, based on the first context, wherein the first execution plan indicates one or more first tasks to be executed in response to the first context, and one or more second execution plans, based on the first context, wherein the one or more second execution plans indicate one or more second tasks to be executed as response to the first context. The instructions, when executed by the at least one processor, may cause the at least one processor to generate a first timeline connecting the first execution plan and the one or more second execution plans. The instructions, when executed by the at least one processor, may cause the at least one processor to detect a change from the first context based on the first timeline and at least one of a second context of the AI-based assistance device or a second context of the user. The instructions, when executed by the at least one processor, may cause the at least one processor to generate an updated execution plan based on the change. The instructions, when executed by the at least one processor, may cause the at least one processor to generate a second timeline by modifying the first timeline based on the updated execution plan

Unless stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, or rearranged for example, to produce additional embodiments within the scope of the disclosure.

While at least one example embodiment has been presented in the foregoing detailed description, it should be appreciated that variations may exist.

What is claimed is:

1. A method for managing an execution plan for an artificial intelligence (AI)-based assistance device, the method comprising:
receiving a first input, via a microphone, indicating a voice command from a user;
determining a first context associated with the AI-based assistance device and a user intent, based on the first input;
generating a first execution plan, based on the first context, wherein the first execution plan indicates one or more first tasks to be executed in response to the first context, and one or more second execution plans, based on the first context, wherein the one or more second execution plans indicate one or more second tasks to be executed in response to the first context;
generating a first timeline connecting the first execution plan and the one or more second execution plans;
detecting a change from the first context based on the first timeline and at least one of a second context of the AI-based assistance device or a second context of the user;
generating an updated execution plan based on the change; and
generating a second timeline by modifying the first timeline based on the updated execution plan.

2. The method as claimed in claim 1, wherein, prior to the determining the first context, the method comprises:
generating a text format corresponding to the first input by converting the first input into text based on an automated speech recognition (ASR) model; and
segregating the text format into a plurality of domains by classifying the text format based on a natural level understanding (NLU) model.

3. The method as claimed in claim 1, wherein determining the first context, the method comprising:
generating word embeddings corresponding to the first input based on a conversion of a segregated text format corresponding to the first input into the word embeddings;
identifying a plurality of pieces of data corresponding to the first input, based on a vector search of the word embeddings in a predefined vector database, wherein the plurality of pieces of data indicates a plurality of services associated with the first input;
generating a predetermined number of prioritized pieces of data, corresponding to the first input, from the plurality of pieces of data by re-ranking the plurality of pieces of data based on the first input, wherein the predetermined number of prioritized pieces of data indicate one or more pieces of data having highest ranks compared with remaining pieces of data from among the plurality of pieces of data;
providing, from a plurality of external services provider, information corresponding to a plurality of external services upon requesting the plurality of external services based on the predetermined number of prioritized pieces of data, and the first input, wherein the information corresponding to the plurality of external services indicates a plurality of operations associated with the first input;
determining the first context, based on merging the information corresponding to the plurality of external services and a plurality of predetermined pieces of custom data, and multi-device environment (MDE) data.

4. The method as claimed in claim 1, wherein the generating the first execution plan and the one or more second execution plans comprises:
merging the first context and an outcome of a query corresponding to the first input;
extracting activity information corresponding to a plurality of future activities to be performed, based on at least one of: a fine-tuning technique, an adapter technique or a rag technique, wherein the activity information corresponds to the first input and a plurality of categories of predefined activities; and
generating the first execution plan and the one or more second execution plans based on the activity information and the plurality of categories.

5. The method as claimed in claim 4, further comprising:
segregating the first execution plan and the one or more second execution plans into a plurality of pre-determined groups, wherein the plurality of pre-determined groups comprises a proactive multi domain task group, a personalized dynamic recommendation group, and multi-device assistance group.

6. The method as claimed in claim 1, wherein the generating the first timeline comprises:
aggregating the first execution plan and the one or more second execution plans, after segregating the first execution plan and the one or more second execution plans into a plurality of pre-determined groups, via an aggregator cache based on a plurality of parameters comprising a location, and a time; and
transmitting the aggregated first execution plan and the one or more second execution plans to a dynamic execution plan generator in a sequential order.

7. The method as claimed in claim 6, wherein the generating the first timeline comprises:
processing the aggregated first execution plan and the one or more second execution plans, via a neural network of the dynamic execution plan generator, based on a plurality of predetermined factors comprising a priority policy, a parameter dependency tracker, and a text map; and
generating an interconnected first execution plan and the one or more second execution plans and the first timeline connecting the interconnected first execution plan and the one or more second execution plans.

8. The method as claimed in claim 7, further comprising:
segregating the interconnected first execution plan and the one or more second execution plans based on a plurality of predetermined segments, wherein the plurality of predetermined segments comprises a context monitoring service segment, a state monitoring service segment, an execution plan validator segment, and an execution scheduler segment;
analyzing a validation of the segregated interconnected first execution plan and the one or more second execution plans based on a real-time status of the user and the first context; and
transmitting information to a user equipment of the user to cause the user equipment to execute the segregated interconnected first execution plan and the one or more second execution plans on the user equipment, based on the segregated interconnected first execution plan and the one or more second execution plans being validated.

9. The method as claimed in claim 1, wherein the detecting the change comprises:
detecting the change from the first context, based on correlating the first timeline with at least one of the second context or the second context of the user, via a context monitoring service; and
detecting a change of a plurality of variables associated with the first execution plan and the one or more second execution plans, based on correlating the first timeline with at least one of the second context or the second context of the user, via a state monitoring service or an execution plan validator, wherein the plurality of variables comprises an initial state of at least one of user equipment, a type of at least one of the user equipment, and a plan provided in the first execution plan and at least one of the one or more second execution plans.

10. The method as claimed in claim 1, wherein the updated execution plan indicates an extension of the one or more second execution plans or a replacement of the one or more second execution plans.

11. A system for managing an execution plan for an artificial intelligence (AI)-based assistance device, the system comprising:
memory storing instructions;
at least one processor in communication with the memory,
wherein the instructions, when executed by the at least one processor, cause the system to:
receive a first input, via a microphone, indicating a voice command from a user;
determine a first context associated with the AI-based assistance device and a user intent, based on the first input;
generate a first execution plan, based on the first context, wherein the first execution plan indicates one or more first tasks to be executed in response to the first context, and one or more second execution plans, based on the first context, wherein the one or more second execution plans indicate one or more second tasks to be executed as response to the first context;
generate a first timeline connecting the first execution plan and the one or more second execution plans;
detect a change from the first context based on the first timeline and at least one of a second context of the AI-based assistance device or a second context of the user;
generate an updated execution plan based on the change; and
generate a second timeline by modifying the first timeline based on the updated execution plan.

12. The system as claimed in claim 11, wherein the instructions, when executed by the at least one processor, cause the system to:
generate a text format corresponding to the first input by converting the first input into text based on an automated speech recognition (ASR) model; and
segregate the text format into a plurality of domains by classifying the text format based on a natural level understanding (NLU) model.

13. The system as claimed in claim 11, wherein the instructions, when executed by the at least one processor, cause the system to:
generate word embeddings corresponding to the first input based on a conversion of a segregated text format corresponding to the first input into the word embeddings;
identify a plurality of pieces of data corresponding to the first input, based on a vector search of the word embeddings in a predefined vector database, wherein the plurality of pieces of data indicates a plurality of services associated with the first input;
generate a predetermined number of prioritized pieces of data, corresponding to the first input, from the plurality of pieces of data by re-ranking the plurality of pieces of data based on the first input, wherein the predetermined number of prioritized pieces of data indicate one or more pieces of data having highest ranks compared with remaining pieces of data from among the plurality of pieces data;
provide, from a plurality of external services provider, information corresponding to a plurality of external services upon requesting the plurality of external services based on the predetermined number of prioritized pieces of data, and the first input, wherein the information corresponding to the plurality of external services indicates a plurality of operations associated with the first input; and
determine the first context, based on merging the information corresponding to the plurality of external services and a plurality of predetermined pieces of custom data, and multi-device environment (MDE) data.

14. The system as claimed in claim 11, wherein the instructions, when executed by the at least one processor, cause the system to:
merge the first context and an outcome of a query corresponding to the first input;
extract activity information corresponding to a plurality of future activities to be performed, based on at least one of: a fine-tuning technique, an adapter technique or a rag technique, wherein the activity information corresponds to the first input and a plurality of categories of predefined activities; and
generate the first execution plan and the one or more second execution plans based on the activity information and the plurality of categories.

15. The system as claimed in claim 14, wherein the instructions, when executed by the at least one processor, further cause the system to:
segregate the first execution plan and the one or more second execution plans into a plurality of pre-determined groups, wherein the plurality of pre-determined groups comprises a proactive multi domain task group, a personalized dynamic recommendation group, and a multi-device assistance group.

16. The system as claimed in claim 11, wherein the instructions, when executed by the at least one processor, cause the system to:
aggregate the first execution plan and the one or more second execution plans, after segregating the first execution plan and the one or more second execution plans into a plurality of pre-determined groups, via an aggregator cache based on a plurality of parameters comprising a location, and a time; and
transmit the aggregated first execution plan and the one or more second execution plans to a dynamic execution plan generator in a sequential order.

17. The system as claimed in claim 16, wherein the instructions, when executed by the at least one processor, cause the system to:
process the aggregated first execution plan and the one or more second execution plans, via a neural network of the dynamic execution plan generator, based on a plurality of predetermined factors comprising a priority policy, a parameter dependency tracker, and a text map; and
generate an interconnected first execution plan and the one or more second execution plans and the first timeline connecting the interconnected first execution plan and the one or more second execution plans.

18. The system as claimed in claim 17, wherein the instructions, when executed by the at least one processor, further cause the system to:
segregate the interconnected first execution plan and the one or more second execution plans based on a plurality of predetermined segments, wherein the plurality of predetermined segments comprises a context monitoring service segment, a state monitoring service segment, an execution plan validator segment, and an execution scheduler segment;
analyze a validation of the segregated interconnected first execution plan and the one or more second execution plans based on a real-time status of the user and the first context; and
transmit information to a user equipment of the user to cause the user equipment to execute the segregated interconnected first execution plan and the one or more second execution plans on the user equipment, based on the segregated interconnected first execution plan and the one or more second execution plans being validated.

19. The system as claimed in claim 11, wherein the instructions, when executed by the at least one processor, cause the system to:
detect the change from the first context, based on correlating the first timeline with at least one of the second context or the second context of the user, via a context monitoring service; and
detect a change of a plurality of variables associated with the first execution plan and the one or more second execution plans based on correlating the first timeline with at least one of the second context or the second context of the user, via a state monitoring service or an execution plan validator, wherein the plurality of variables comprises an initial state of at least one of user equipment, a type of at least one of the user equipment, and a plan provided in the first execution plan and at least one of the one or more second execution plans.

20. A non-transitory computer-readable storage medium storing instructions that, when executed by at least one processor, cause the at least one processor to:
receive a first input, via a microphone, indicating a voice command from a user;
determine a first context associated with the AI-based assistance device and a user intent, based on the first input;
generate a first execution plan, based on the first context, wherein the first execution plan indicates one or more first tasks to be executed in response to the first context, and one or more second execution plans, based on the first context, wherein the one or more second execution plans indicate one or more second tasks to be executed as response to the first context;
generate a first timeline connecting the first execution plan and the one or more second execution plans;
detect a change from the first context based on the first timeline and at least one of a second context of the AI-based assistance device or a second context of the user;
generate an updated execution plan based on the change; and
generate a second timeline by modifying the first timeline based on the updated execution plan.
